(19) United States
(12) Patent Application Publication
(10) Pub. No.: US 2010/0296069 A1
(43) Pub. Date: Nov. 25, 2010

(54) Pattern division method, pattern division processing apparatus and information storage medium on which is stored a program

(75) Inventor: Seiji Matsuura, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki-shi (JP)

(21) Appl. No.: 12/662,959

(22) Filed: May 13, 2010

(30) Foreign Application Priority Data
May 22, 2009 (JP) 2009-124421

(51) Int. Cl. G03B 27/42

(52) U.S. Cl. 355/53; 355/77

(57) ABSTRACT

There is provided a pattern division method to form crowded patterns accurately on a substrate includes acquiring a mask pattern, dividing a predetermine area into a plurality of areas to prepare a division pattern in which the plurality of the areas are classified into first and second groups, generating a reduced mask pattern by reducing each of two or more patterns laid out in the object mask pattern substantially toward the center of the particular pattern, overlapping the division pattern with the reduced mask pattern and extracting the reduced patterns overlapped with the area classified as the first group of the division pattern to generate a first reduced mask pattern, and restoring the reduced patterns laid out in the first reduced mask pattern to the original size before generation of the reduced mask pattern.

This application is based on Japanese Patent Application No. 2009-124421, the content of which is incorporated hereinto by reference.

### BACKGROUND

1. Technical Field

The present invention relates to a pattern division method, a pattern division processing apparatus and an information storage medium on which is stored a program.

2. Related Art

With the recent trend toward micronization of a semiconductor device, it has become more and more difficult to form crowded patterns by photolithography. Therefore, what is called the double patterning method has come to be used in which crowded patterns are accurately formed on a substrate through a plurality of exposure and processing sessions. The greater the number of divisions, the greater the number of photomasks required, resulting in an increased production cost. Virtually, therefore, the use of not more than two divisions is a prerequisite for the double patterning method.

The double patterning method requires a technique whereby a mask pattern having laid out therein a design data in a vast information amount such as a plurality of hole patterns is divided into two groups accurately and efficiently, and each group is mounted on a different photomask. This technique is described, for example, in Japanese Laid-Open Patent Publication No. 2007-258366.

In the technique described in Japanese Laid-Open Patent Publication No. 2007-258366, grids GR having a unit length equal to the minimum pitch of the hole patterns are arranged in the overall hole pattern U having a plurality of hole patterns laid out therein as an object data to be divided. The vertical lines VL of the grids GR are assigned theoretical values “0” and “1”, alternately. The horizontal lines HL are similarly assigned theoretical values “0” and “1”, alternately.

Next, with regard to each of all the holes laid out in the entire hole pattern U, the vertical line VL and the horizontal line HL nearest from the center of the particular hole are extracted. Then, the exclusive-OR is calculated between the theoretical values assigned to the extracted vertical line VL and the extracted horizontal line HL.

After that, according to the value of the exclusive-OR calculated for each hole, all the holes are divided into group “0” and group “1”, and the holes of each group are mounted on a different photomask.

The present inventor has recognized as follows.

In one method for dividing an object mask pattern to be divided into two groups, the object mask pattern is divided in such a manner that the nearest patterns are associated with different groups. By employing this method, each of specific regular mask patterns to be divided as shown in FIGS. 13 and 14 can be accurately and efficiently divided into two groups. FIGS. 13 and 14 show the manner in which a mask pattern having a plurality of patterns 1 laid out therein is divided into a first mask pattern having a plurality of patterns 1A and a second mask pattern having a plurality of patterns 1B.

In the method for dividing the nearest patterns into different groups, however, a mask pattern having three or more nearest patterns as shown in FIGS. 15 and 16, for example, cannot be divided into two groups without any conflict. In fact, the regular mask patterns as shown in FIGS. 13 and 14 are rarely used, and most mask patterns have an irregular pattern layout. In the mask pattern having an irregular pattern layout, as shown in FIG. 15, three or more nearest patterns often exist. In other words, the mask pattern division method to divide the nearest patterns into different groups is not substantially practicable.

Also, the technique described in Japanese Laid-Open Patent Publication No. 2007-258366 requires the identification of all the patterns laid out in the object mask pattern and the execution of a plurality of processes including “extraction of the vertical line VL and the horizontal line HL”, “execution of the arithmetic process” for each pattern and “holding the calculation result related to each pattern”. This increases the processing amount with the increase in the number of patterns, and imposes a large burden on the device executing the process.

Further, the device and the program to execute this process are required to be generated anew for an increased investment cost.

### SUMMARY

In one embodiment, there is provided a pattern division method to divide at least two patterns laid out in one mask pattern into a first mask pattern and a second mask pattern, including:

acquiring an object mask pattern providing a mask pattern to be divided;

preparing a division pattern by dividing a predetermined area into a plurality of areas and classifying the plurality of the areas into first and second groups in a staggered fashion;

reducing each of the at least two patterns laid out in the object mask pattern substantially toward the center of the particular pattern and generating a reduced mask pattern with the reduced patterns laid out therein as patterns after reduction;

overlapping the division pattern with the reduced mask pattern and extracting the reduced patterns overlapped with the area of the division pattern classified as the first group thereby to generate a first reduced mask pattern; and

restoring the reduced patterns laid out in the first reduced mask pattern to the original size before generation of the reduced mask pattern thereby to generate the first mask pattern.

In another embodiment, there is provided a pattern division processing apparatus which divides at least two patterns laid out in one mask pattern into a first mask pattern and a second mask pattern, including:

an object mask pattern acquisition unit which acquires an object mask pattern providing a mask pattern to be divided;

a division pattern preparation unit which prepares a division pattern by dividing predetermined area into a plurality of areas and classifying the plurality of the areas into first and second groups in a staggered fashion;

a reduced mask pattern generation unit which reduces each of the at least two patterns laid out in the object mask pattern substantially toward the center of the particular pattern and generates a reduced mask pattern with the reduced patterns laid out therein as patterns after reduction;

a first reduced mask pattern generation unit which overlaps the division pattern with the reduced mask pattern and extracts the reduced patterns overlapped with the area of the division pattern classified as the first group thereby to generate a first reduced mask pattern; and

a first mask pattern generation unit which restores the reduced patterns laid out in the first reduced mask pattern to the original size before reduction by the reduced mask pattern generation unit thereby to generate a first mask pattern.

In still another embodiment, there is provided an information storage medium on which is stored a program for the pattern division processing apparatus, including:

an object mask pattern acquisition process to acquire an object mask pattern providing a mask pattern to be divided;

a division pattern preparation process to prepare a division pattern by dividing a predetermined area into a plurality of areas and classify the plurality of the areas into first and second groups in a staggered fashion;

a reduced mask pattern generation process to reduce each of the at least two patterns laid out in the object mask pattern substantially toward the center of the particular pattern and generate a reduced mask pattern with the reduced patterns laid out therein as patterns after reduction;

a first reduced mask pattern generation process to overlap the division pattern with the reduced mask pattern and extract the reduced patterns overlapped with the area of the division pattern classified as the first group thereby to generate a first reduced mask pattern;

a first mask pattern generation process to restore the reduced patterns laid out in the first reduced mask pattern to the original size before generation of the reduced mask pattern thereby to generate a first mask pattern; and

a second mask pattern generation process to extract the patterns laid out in the first mask pattern from the at least two patterns laid out in the object mask pattern thereby to generate a second mask pattern.

According to this invention, each of two or more patterns laid out in an object mask pattern to be divided is reduced substantially toward the center of the particular pattern and overlapped with a division pattern with a predetermined area divided into a first group and a second group. Then, according to which of the first group or the second group each pattern thus reduced is located, the at least two patterns are divided into two groups. Specifically, since the reduced patterns are overlapped with the division pattern, each pattern is located in one but not both of the first and second groups of the division pattern.

In an object mask pattern having patterns laid out irregularly, therefore, two or more patterns laid out therein can be divided into two groups without any conflict.

The pattern division method, the pattern division processing apparatus and the computer program executed for the pattern division processing apparatus according to this invention make it possible to form crowded patterns accurately on a substrate.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1(1) to 1(6) are schematic diagrams for explaining a pattern division method according to a first embodiment;

FIG. 2A is a function block diagram showing the pattern division processing apparatus according to the first embodiment;

FIG. 2B is a flowchart for the pattern division method according to the first embodiment;

FIGS. 3(1) and 3(2) are schematic diagrams for explaining a mask pattern and a division pattern;

FIGS. 4 to 7 are schematic diagrams for explaining an example of the division pattern;

FIG. 8(1) to 8(3) are schematic diagrams for explaining the effects of the invention;

FIG. 9 is a graph for explaining the effects of the invention;

FIG. 10 is a flowchart for the pattern division method according to the first embodiment;

FIG. 11A is a function block diagram for the pattern division processing apparatus according to a second embodiment;

FIG. 11B is a flowchart for the pattern division method according to the second embodiment;

FIG. 12 is a schematic diagram for explaining a mask pattern and a division pattern;

FIGS. 13 and 14 are schematic diagrams for explaining the manner in which the mask pattern is divided; and

FIGS. 15 and 16 each shows an example of the mask pattern.

### DETAILED DESCRIPTION

The invention will be now described herein with reference to illustrative embodiments. Those skilled in the art will recognize that many alternative embodiments can be accomplished using the teachings of the present invention and that the invention is not limited to the embodiments illustrated for explanatory purposes.

Embodiments of the invention are described below with reference to the drawings. In all the drawings, similar component elements are designated by the same reference numerals, respectively, and the description thereof will not be repeated.

Incidentally, each part constituting the pattern division processing apparatus according to each embodiment is realized by an arbitrary combination of hardware and software of an arbitrary computer built around a CPU, a memory, a program loaded in the memory (including the program stored beforehand in the memory at the time of shipment of the apparatus and any program downloaded from a storage medium such as a CD or a server on the internet), a storage unit such as a hard disk storing the program and an interface for connection to a network. As understood to those skilled in the art, the method and the apparatus are realized by various modifications.

Also, the function block diagrams used for explaining the embodiments show blocks not by hardware but by function. In these drawings, the apparatus according to the embodiments is described to be realized with a single apparatus. Nevertheless, the method for realizing the apparatus is not limited to such a configuration. In other words, the apparatus can be realized in any configuration divided either physically or logically.

### First Embodiment

### Configuration of First Embodiment

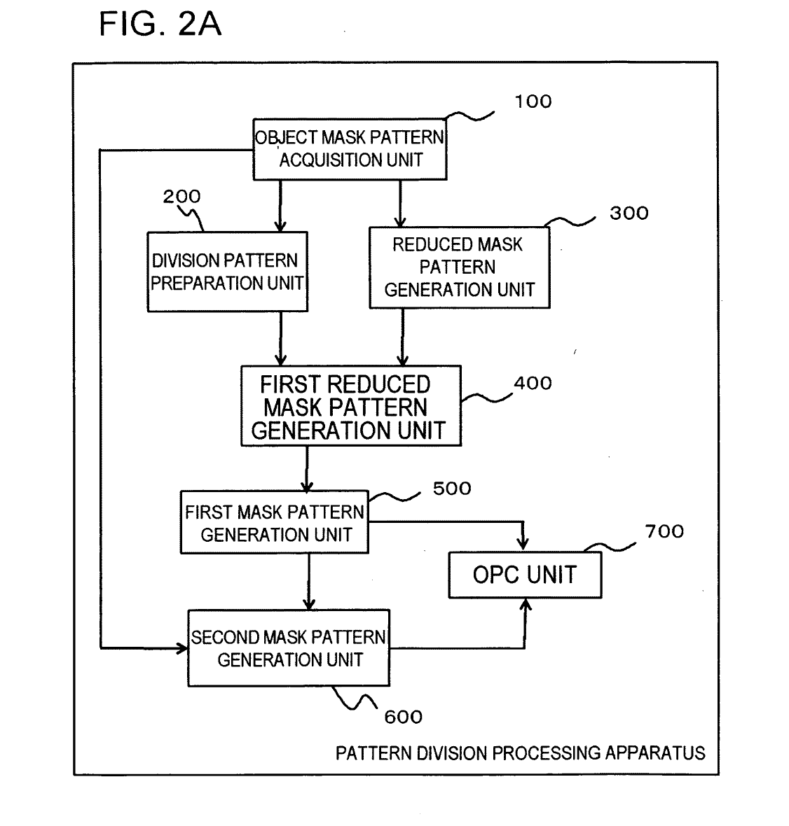

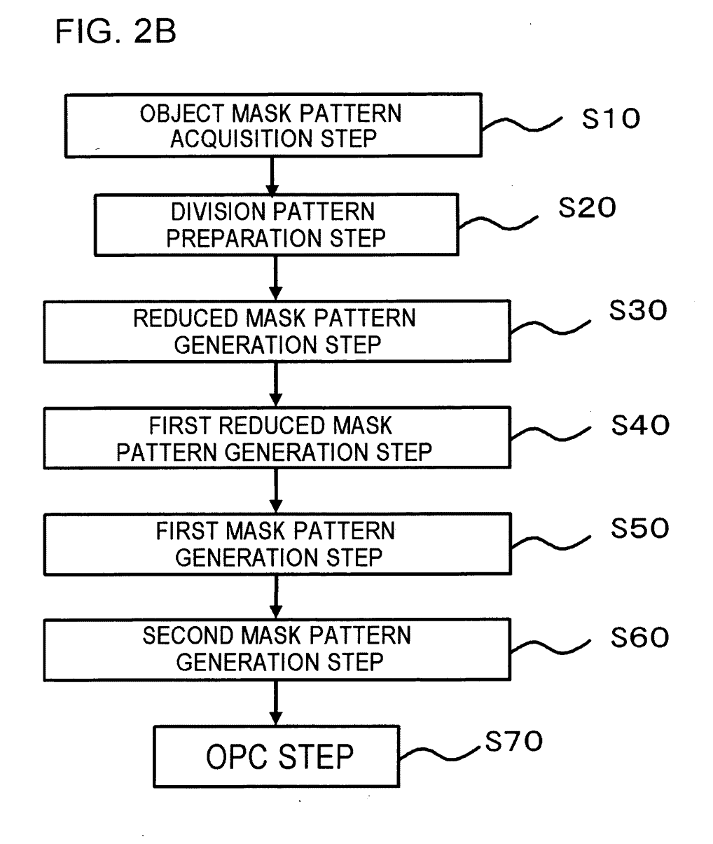

The pattern division processing apparatus according to this embodiment, as shown in the function block diagram of FIG. 2A, includes an object mask pattern acquisition unit 100, a division pattern preparation unit 200, a reduced mask pattern generation unit 300, a first reduced mask pattern generation unit 400, a first mask pattern generation unit 500, a second mask pattern generation unit 600 and an OPC (optical proximity correction) unit 700. Incidentally, depending on the layout of the mask pattern, the OPC unit 700 may be done without. Also, the apparatus can generate the second mask pattern by other than the second mask pattern generation unit 600 which may be lacking.

The configuration of the pattern division processing apparatus according to this embodiment is described in detail below.

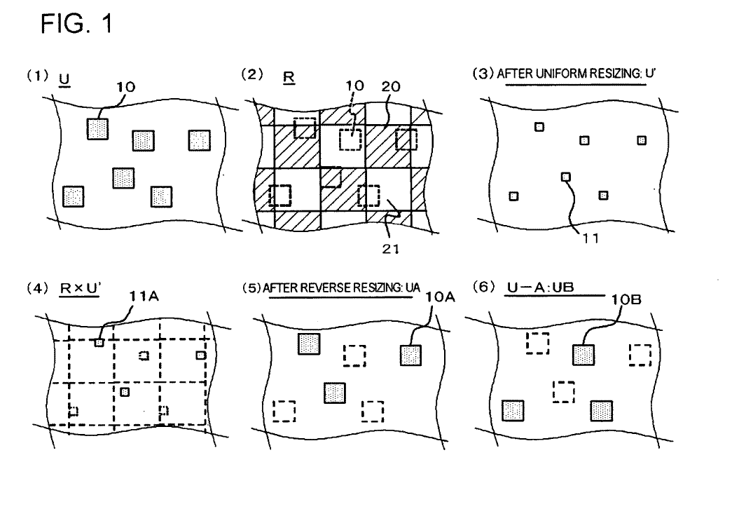

In the pattern division processing apparatus according to this embodiment, two or more patterns laid out in one mask pattern U are divided into first and second mask patterns. For example, one mask pattern U having two or more hole patterns 10 laid out therein as shown in FIG. 1(1) is divided into a first mask pattern UA having two or more hole patterns 10A laid out therein as shown in FIG. 1(5) and a second mask pattern UB having two or more hole patterns 10B laid out therein as shown in FIG. 1(6). Incidentally, FIGS. 1(1) to (6) are schematic diagrams showing only a partial area of the mask pattern or the division pattern referred to in the description that follows.

The object mask pattern acquisition unit 100 is configured to acquire the object mask pattern U to be divided as shown in FIG. 1(1). The division process is executed to divide two or more patterns laid out in the object mask pattern U, into a first mask pattern UA (shown in FIG. 1(5), for example) and a second mask pattern UB (shown in FIG. 1(6), for example).

A specific method by which the object mask pattern acquisition unit 100 acquires the object mask'pattern U is not specifically limited, and the object mask pattern U may be retrieved from other than the pattern division processing apparatus according to this embodiment by either a wired or wireless communication or from the memory of the pattern division processing apparatus according to this embodiment.

The division pattern preparation unit 200, as shown in FIG. 1(2), configured to divide a predetermined area into a plurality of areas and classify the plurality of the areas into first and second groups in a staggered fashion thereby to prepare a division pattern R. Incidentally, the patterns 10 laid out in the object mask pattern U are designated by a dashed line on the division pattern R.

The division pattern R shown in FIG. 1(2) is a checkered pattern in which first rectangles 20 and second rectangles 21 in the same shape as the first rectangles 20 are arranged in a staggered fashion. With this checkered pattern, the predetermined area is divided into a first and a second groups. Specifically, in the predetermined area, the area occupied by the first rectangles 20 is classified as the first group and the area occupied by the second rectangles 21 as the second group.

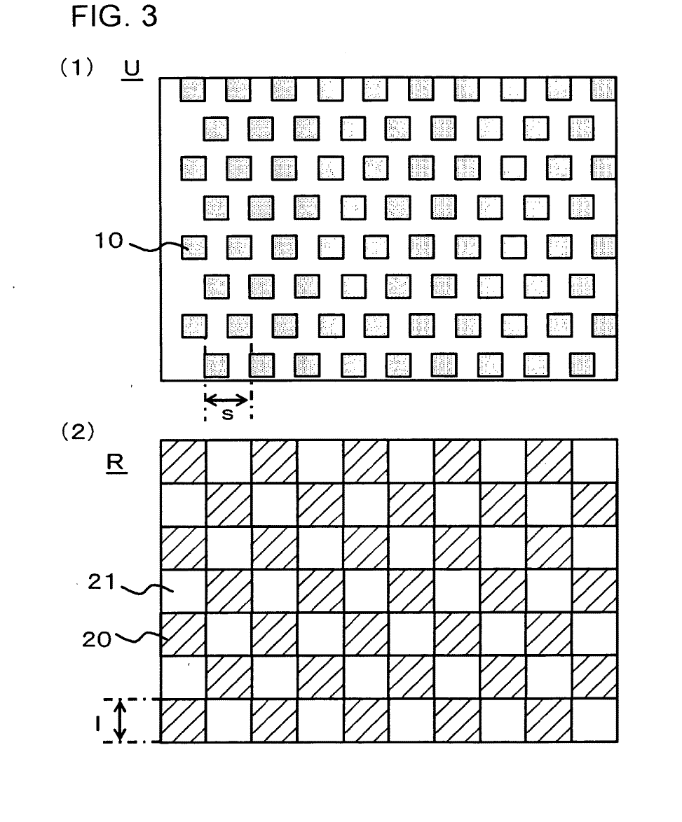

Incidentally, the first rectangles 20 and the second rectangles 21 making up the checkered pattern are desirably squares (FIG. 3(2)) each having the side length of 1 equal to the minimum pitch s of the patterns 10 laid out in the object mask pattern (FIG. 3(1)). The minimum pitch s is defined as the minimum pitch between the patterns 10 determined according to the design rule for the object mask pattern U. In this division pattern R, assuming that the division pattern R and the object mask pattern U are overlapped, one pattern 10 is contained substantially in each of the first rectangles 20 or the second rectangles 21 as shown in FIG. 1(2). As a result, the object mask pattern U may be divided into two groups free of any locally overcrowded portions as far as possible. The related mechanism becomes apparent from the description of other component elements below, and therefore, the description of the mechanism is not repeated.

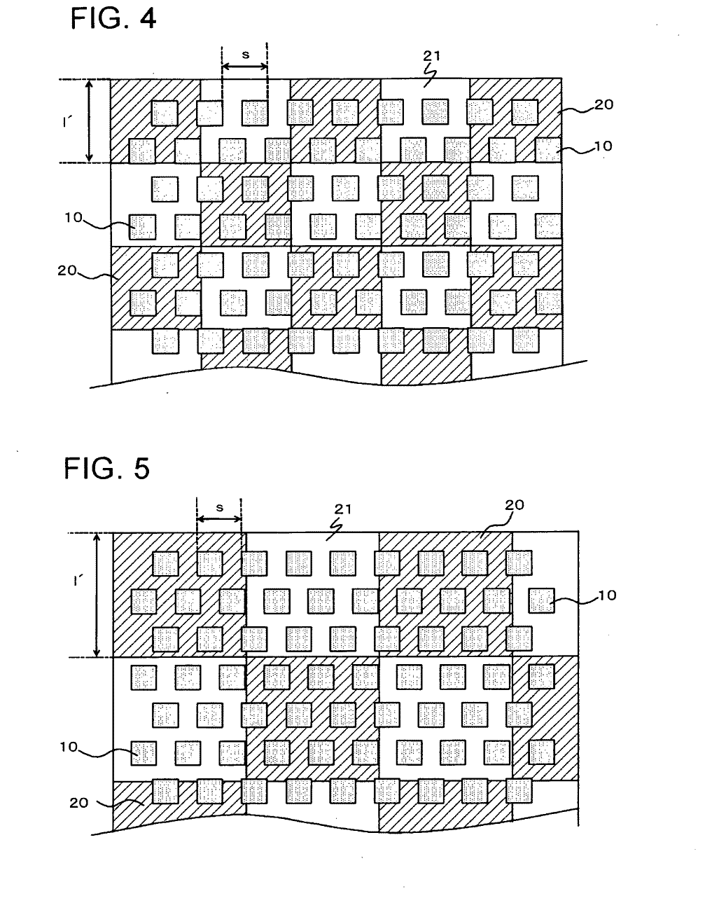

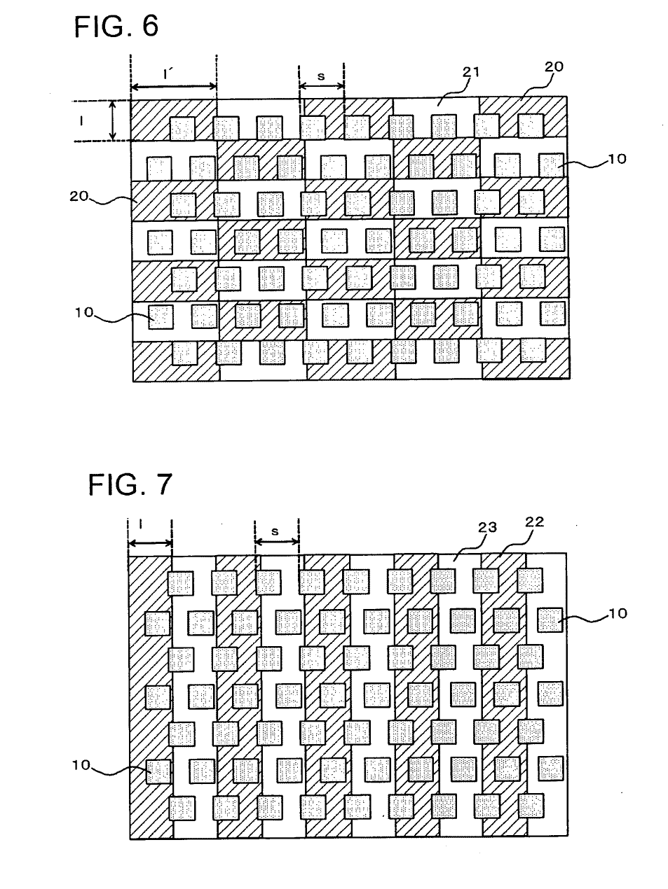

The division pattern R prepared by the division pattern preparation unit 200 is not limited to the one shown in FIG. 3(2), but may alternatively be any of the patterns shown in FIGS. 4 and 5. The division pattern R shown in FIGS. 4 and 5 is a checkered pattern configured of a plurality of squares (first rectangles 20 and second rectangles 21) having the side length 1′ somewhat larger than the minimum pitch s of the two or more patterns 10 laid out in the object mask pattern U. The length 1′ of each side of the square (first rectangle 20, second rectangle 21) may be set at an arbitrary size. Depending on the layout of the object mask pattern U, however, an excessively large size 1′ would leave a locally overcrowded portion in the pattern after division, thereby making it difficult to form a crowded pattern accurately on the substrate. Thus, the size 1′ desirably has an upper limit of about 2 s to 5 s. Incidentally, FIGS. 4 and 5 are diagrams each showing the division pattern R and the object mask pattern U overlapped one on the other. This configuration is similar to the configuration described with reference to FIGS. 6 and 7.

The division pattern R as shown in FIG. 6 may alternatively be prepared by the division pattern preparation unit 200. The division pattern R shown in FIG. 6 is a checkered pattern in which oblongs (first rectangles 20, second rectangles 21) having one side length 1 equal to the minimum pitch s of the two or more patterns 10 laid out in the object mask pattern U are arranged in a staggered fashion. The other side length 1′ of the oblongs (first rectangles 20, second rectangles 21) may be set at an arbitrary size. Depending on the layout of the object mask pattern U, however, an excessively large size 1′ would leave a locally overcrowded portion in the pattern after division, thereby making it difficult to form a crowded pattern accurately on the substrate. Therefore, the upper limit of the size 1′ is desirably about 2 s to 5 s.

As another alternative, the division pattern R prepared by the division pattern preparation unit 200 may be in such a shape as shown in FIG. 7 instead of the checkered pattern described above. The division pattern R shown in FIG. 7 is a striped pattern in which a plurality of oblongs (first oblongs 22 and second oblongs 23) having one side length 1 equal to the minimum pitch s of two or more patterns 10 laid out in the object mask pattern U are arranged in a staggered fashion.

The division pattern R, in which a plurality of rectangles (first rectangles 20, second rectangles 21, first oblongs 22 and second oblongs 23) having a comparatively large side length are arranged in a staggered fashion as shown in FIGS. 4, 5, 6 and 7, as compared with the division pattern R (FIG. 3(2), for example) in which a plurality of rectangles having a comparatively small side length are arranged in a staggered fashion, can reduce the data amount of the very division pattern R, and therefore, advantageously reduce the burden imposed on the apparatus in the execution of the process described below using the division pattern R.

Incidentally, it is the matter of design consideration which type of the plurality of the variations of the division pattern R is to be prepared by the object mask pattern acquisition unit 100, and the apparatus can be configured to prepare one division pattern R out of the plurality of the variations according to the user operation. In such a case, the user can select one division pattern R arbitrarily according to the layout of the object mask pattern U or the required resolution.

A specific method by which the division pattern preparation unit 200 prepares the division pattern R can be realized by, for example, generating the division pattern R having the aforementioned layout according to the layout of the object mask pattern U acquired by the object mask pattern acquisition unit 100. Specifically, the minimum pitch of two or more patterns 10 laid out in the object mask pattern U is identified using the object mask pattern U acquired by the object mask pattern acquisition unit 100, and by use of the minimum pitch thus identified, the division pattern R having the layout described above may be generated. The minimum pitch, if associated with the object mask pattern U, may be identified by acquiring the particular information. The minimum pitch, if not associated with the object mask pattern U, on the other hand, may be identified by calculation using the object mask pattern U.

The division pattern R described above can be generated by the normal pattern generating method using a pattern generating tool in wide use. Incidentally, as another specific method for preparing the division pattern R, the division pattern R stored in the pattern division processing apparatus according to this embodiment may be retrieved in advance.

The reduced mask pattern generation unit 300 is configured in such a manner that two or more patterns 10 laid out in the object mask pattern U as shown in FIG. 1(1) are each reduced substantially toward the center thereof thereby to generate a reduced mask pattern U′ with reduced patterns 11 laid out therein as shown in FIG. 1(3) as a pattern after reduction. Incidentally, the degree of reduction, which can be determined in a design stage according to the layout of the object mask pattern U, is required to be such that in the case where the division pattern R shown in FIG. 1(2) prepared by the division pattern preparation unit 200 is overlapped with the reduced mask pattern U′ shown in FIG. 1(3), each reduced pattern is contained in its entirety in any one of the first rectangles 20 or the second rectangles 21 of the division pattern R. As a specific method for realizing this reduction, assume a case in which the pattern 10 before reduction is a square (having the side length of m) as shown in FIG. 1(1). In this case, the reduction may be realized by generating a square having the same center position as the square before reduction (pattern 10) and having the side length equal to the sum of the side length (m) of the square before reduction (pattern 10) and “−m +α” (α: sufficiently small positive number). This process is equivalent to generation of a square (reduced pattern 11) having the same center position as the square before reduction (pattern 10) and having a side length α (α: sufficiently small positive number). Specifically, by designing the value α (α: sufficiently small positive number) appropriately, the degree, of reduction can be freely manipulated. Incidentally, the reduction process can be executed also by the reduced mask pattern generation unit 300 using other methods.

The first reduced mask pattern generation unit 400 is configured to generate a first reduced mask pattern R×U′ shown in FIG. 1(4) by overlapping the division pattern R shown in FIG. 1(2) with the first reduced mask pattern U′ shown in FIG. 1(3) and extracting the reduced patterns 11A overlapped with the area (the area occupied by the first rectangles 20) classified as the first group of the division pattern R. Incidentally, in FIG. 1(4), the solid rectangles indicate the reduced patterns 11A, and the dashed rectangles the reduced patterns 11 not extracted and the division pattern R.

The first reduced mask pattern generation unit 400 executing this process can be implemented by, for example, a widely-used tool dedicated to what may be called “the layer combination and bias process”. With this tool, the first reduced mask pattern R×U′ with the reduced patterns 11A laid out therein can be generated by the AND operation of the division pattern R and the first reduced mask pattern U′. Incidentally, the desired first reduced mask pattern R×U′ can be generated also by executing the OR or NOT operation.

The first mask pattern generation unit 500 is so configured as to generate the first mask pattern UA having laid out therein the patterns 10A as shown in FIG. 1(5) in such a manner that the reduced patterns 11A laid out in the first reduced mask pattern R×U′ as shown in FIG. 1(4) are restored to the original size before reduction by the reduced mask pattern generation unit 300. The process to restore the original size of the reduced patterns 11A can be realized by executing the process inverse to the process executed by the reduced mask pattern generation unit 300. Assume, for example, that the reduced mask pattern generation unit 300 realizes the reduction process by generating a square (reduced pattern 11) having the same center position as the square before reduction (pattern 10) and having the side length equal to the sum of the side length of the square before reduction (pattern 10) and “−m +α” (α:

sufficiently small positive number). Then, the original size of the reduced pattern 11A can be restored by the process of generating a square having the same center position as the reduced pattern 11A and having the side length equal to the sum of the side length of the reduced pattern 11A and “m−a” (α: sufficiently small positive number). By this process, the pattern 10A (FIG. 1(5)) restored to the original size of the reduced pattern 11A (FIG. 1(4)) can be generated.

The second mask pattern generation unit 600 is configured to generate the second mask pattern UB as shown in FIG. 1(6) by the process in which the patterns 10A laid out in the first mask pattern UA shown in FIG. 1(5) are subtracted from the two or more patterns 10 laid out in the object mask pattern U shown in FIG. 1(1). This second mask pattern generation unit 600 can be realized by the aforementioned tool dedicated to the “the layer combination and bias process”.

In the pattern division processing apparatus according to this embodiment including the object mask pattern acquisition unit 100, the division pattern preparation unit 200, the reduced mask pattern generation unit 300, the first reduced mask pattern generation unit 400, the first mask pattern generation unit 500 and the second mask pattern generation unit 600 described above, even an object mask pattern U with patterns laid out irregularly therein can be divided into the first mask pattern UA and the second mask pattern UB without any conflict.

However, in the case where the division pattern R is configured of comparatively large rectangles (first rectangles 20, second rectangles 21, first oblongs 22, second oblongs 23) arranged in a staggered fashion as shown in FIGS. 4 to 7, an area locally crowded with patterns (10A and 11A) is generated in the first mask pattern UA and the second mask pattern UB.

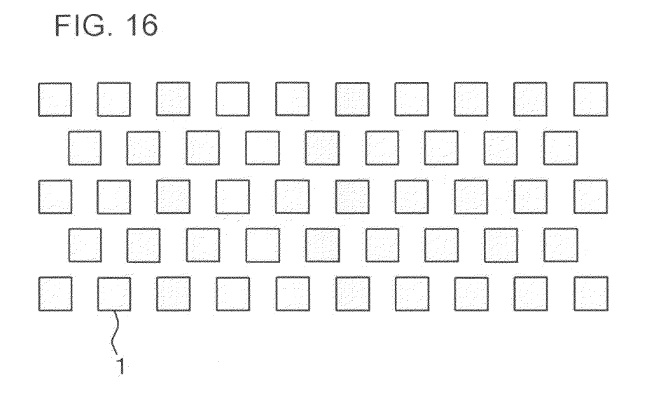

Also, in the case where the object mask pattern has a layout in which the physically nearest patterns cannot be divided into different groups as shown in FIGS. 15 and 16, an area crowded with patterns (10A and 11A) is locally generated in the first mask pattern UA and/or the second mask pattern UB.

The use of a mask pattern having such an area locally crowded with the patterns (10A and 11A) cannot produce a sufficient resolution. In other words, a crowded pattern cannot be accurately formed on the substrate.

In the pattern division processing apparatus according to this embodiment, this inconvenience can be obviated by executing the process with the OPC (optical proximity correction) unit 700 described below on the first mask pattern UA and the second mask pattern UB after division.

The OPC unit 700 is configured to execute the OPC on the first mask pattern UA and the second mask pattern UB. Incidentally, according to the layout of the object mask pattern U, the OPC may be executed on only one of the first mask pattern UA and the second mask pattern UB. The OPC executed by the OPC unit 700 is desirably what is called the model based OPC. The model based OPC is the process in which the characteristics of the resist and the projection optics are modeled and simulated thereby to generate an appropriate pattern. Incidentally, the OPC executed by the OPC unit 700 may alternatively be the rule based OPC.

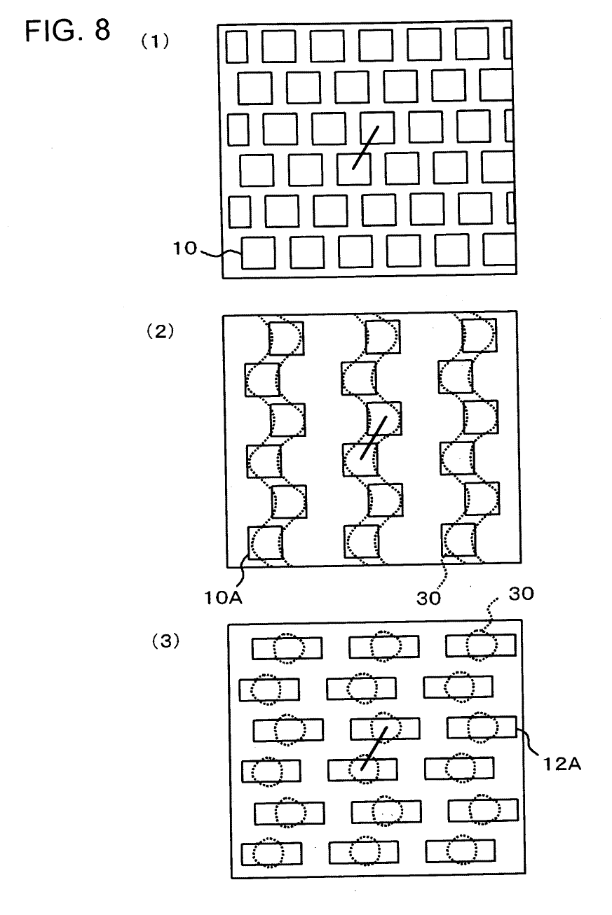

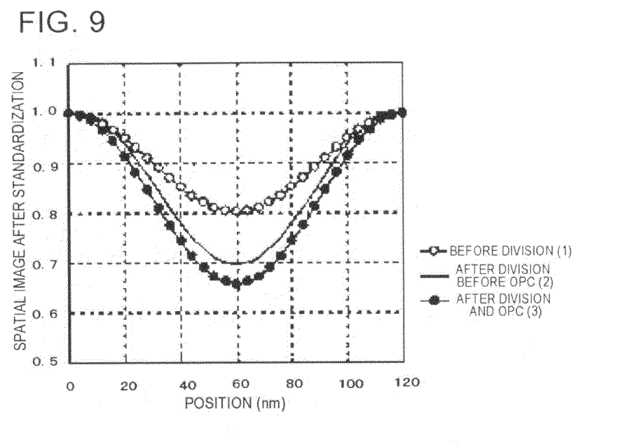

Now, an example of the result of simulation of the model based OPC by the OPC unit 700 is described with reference to FIGS. 8 and 9.

FIG. 8(1) shows the object mask pattern U with two or more patterns 10 laid out therein.

FIG. 8(2) shows the first mask pattern UA with two or more patterns 10A laid out therein. This first mask pattern UA is obtained by dividing the object mask pattern U of FIG. 8(1) using the division processing apparatus according to this embodiment. Incidentally, the patterns 30 formed on the substrate using the first mask pattern UA calculated by simulation are also shown by dashed lines in FIG. 8(2).

FIG. 8(3) shows a mask pattern with the model based OPC conducted on the first mask pattern UA shown in FIG. 8(2). Each pattern 10A is corrected as an oblong 12A by the model based OPC. Incidentally, the patterns 30 formed on the substrate using the mask pattern on which the OPC is conducted with the calculation by simulation are also shown by dashed lines in FIG. 8(3).

FIG. 9 is a graph showing an optical image formed in the case where FIGS. 8(1) to (3) are cut away along the direction toward the nearest position (solid lines in the drawings).

In this simulation, the object mask pattern U shown in FIG. 8(1), through the exposure to ArF (193 nm) liquid and normal illumination with Na of 1.2 and σ of 0.7, is converted to a six-way most crowded pattern of squares having the side length of 80 nm. As an index of resolution, the product NILS (normalized intensity log-slope) of the light intensity gradient (log-slope, (1/I)dl/dx) and the line width is used. To secure the stable resolution, NILS is required to be not less than unity.

In the object mask pattern U shown in FIG. 8(1), the nearest patterns are included in the same mask pattern. This mask pattern has NILS of 0.418 and is not expected to have a sufficient resolution at all (FIG. 9(1)). Incidentally, in the object mask pattern U shown in FIG. 8(1) having a very dense arrangement, a sufficient correction result can not be obtained by the model based OPC.

Also in the first mask pattern UA shown in FIG. 8(2), the nearest patterns are included in the same mask pattern, and retain the same shape without being corrected. This mask pattern has NILS still as low as 0.757 and cannot produce a stable resolution (FIG. 8(2)). In the case where a pattern is formed on the substrate using this mask pattern, as shown in FIG. 8(2), the nearest patterns in the pattern 30 on the substrate are shorted with each other.

In the mask pattern obtained by conducting the OPC on the first mask pattern UA shown in FIG. 8(3), the shape of each pattern 12A is corrected as an oblong of 50 nm by 170 nm, and a sufficient value of NILS of 1.081 can be secured for stable resolution (FIG. 9(3)). In the case where a pattern is formed on the substrate using this mask pattern, as shown in FIG. 8(3), the nearest patterns 30 on the substrate are not shorted with each other. In this way, a crowded pattern can be accurately formed on the substrate.

As described above, with the pattern division processing apparatus according to this embodiment, the crowded patterns can be formed accurately on the substrate. Also, as described above, each part of the pattern division processing apparatus according to this embodiment can be implemented using a tool in general use. Therefore, the pattern division processing apparatus according to this embodiment can be realized by combining the existing tools without producing a new device or creating a program.

The aforementioned pattern division method according to this embodiment can be realized also by causing a computer to execute a program including the process of acquiring the object mask pattern U to be divided, the process of preparing a division pattern R by dividing a predetermined area into a plurality of areas and classifying the plurality of the areas into first and second groups in a staggered fashion, the process of reducing each of two or more patterns 10 laid out in the object mask pattern U, substantially toward the center thereof thereby to generate a reduced mask pattern U′ having laid out therein the reduced patterns 11 as the patterns after reduction, the process of overlapping the division pattern R with the reduced mask pattern U′ and generating a first reduced mask pattern R×U′ by extracting the reduced patterns 11 overlapped with the area classified as the first group of the division pattern R, the process of generating the first mask pattern UA by restoring the reduced mask patterns 11A laid out in the first reduced mask pattern R×U′ to the original size before execution of the reduced mask pattern generation process, the process of generating a second mask pattern UB by subtracting the patterns 10A laid out in the first mask pattern UA from the two or more patterns 10 laid out in the object mask pattern U and the process of conducting the OPC on the first mask pattern UA and the second mask pattern UB. Incidentally, a program not including the OPC process can also be used.

Also, the program described above may be either a single program to execute all the aforementioned processes continuously or a combination of a plurality of programs associated with the aforementioned processes, respectively. This program may be stored in an information storage medium such as a CD.

Next, the pattern division method according to this embodiment is described with reference to the flowchart of FIG. 2B.

The pattern division method according to this embodiment is for dividing two or more patterns laid out in one mask pattern into first and second mask patterns, and as shown in the flowchart of FIG. 2B, includes an object mask pattern acquisition step S10, a division pattern preparation step S20, a reduced mask pattern generation step S30, a first reduced mask pattern generation step S40, a first mask pattern generation step S50, a second mask pattern generation step S60 and an OPC step S70. Incidentally, depending on the mask pattern type, the OPC step S60 may be done without. Also, in the absence of the second mask pattern generation step S50, the second mask pattern can be generated by another step. The pattern division method according to this embodiment can be implemented by, for example, the pattern division processing apparatus according to this embodiment. Each step of the pattern division method according to this embodiment is described below with reference to FIG. 1.

The object mask pattern acquisition step S10 is for acquiring the object mask pattern U to be divided as shown in FIG. 1(1). This step is realized by the process executed by the object mask pattern acquisition unit 100 of the pattern division processing apparatus according to this embodiment.

The division pattern preparation step S20 is a step in which as shown in FIG. 1(2), a predetermined area is divided into a plurality of areas, which are then classified into first and second groups in a staggered fashion thereby to prepare a division pattern R. This step is realized by the process executed by the division pattern preparation unit 200 of the pattern division processing apparatus according to this embodiment.

The reduced mask pattern generation step S30 is a step in which two or more patterns 10 laid out in the object mask pattern U as shown in FIG. 1(1) are each reduced substantially toward the center thereof to generate a reduced mask pattern U′ having laid out therein the reduced patterns 11 as patterns after reduction as shown in FIG. 1(3). This step is realized by the process executed by the reduced mask pattern generation unit 300 of the pattern division processing apparatus according to this embodiment.

The first reduced mask pattern generation step S40 is a step in which the division pattern R shown in FIG. 1(2) is overlapped with the reduced mask pattern U′ shown in FIG. 1(3), and the reduced patterns 11 overlapped with the area (the hatched area in the drawing, for example) classified as the first group of the division pattern R are extracted thereby to generate the first reduced mask pattern R×U′ as shown in FIG. 1(4). This step is realized by the process executed by the first reduced pattern generation unit 400 of the pattern division processing apparatus according to this embodiment.

The first mask pattern generation step S50 is a step in which the reduced patterns 11A laid out in the first reduced mask pattern R×U′ are restored to the original size before execution of the reduced mask pattern generation step S30 thereby to generate the first mask pattern UA shown in FIG. 1(5). This step is realized by the process executed by the first mask pattern generation unit 500 of the pattern division processing apparatus according to this embodiment.

The second mask pattern generation step S60 is a step in which the patterns 10A laid out in the first mask pattern UA are subtracted from the two or more patterns 10 laid out in the object mask pattern U thereby to generate the second mask pattern UB shown in FIG. 1(6). This step is realized by the process executed by the second mask pattern generation unit 600 of the pattern division processing apparatus according to this embodiment.

The OPC step S70 is for conducting the OPC on the first mask pattern UA and the second mask pattern UB. This step is realized by the process executed by the OPC unit 700 of the pattern division processing apparatus according to this embodiment.

Incidentally, the division pattern R prepared by the division pattern preparation step S20 is a checkered pattern in which the first rectangles 20 each having the side length equal to the minimum pitch of the two or more patterns 10 laid out in the object mask pattern U and the second rectangles in the same shape as the first rectangles 20 are arranged in a staggered fashion, and in which the area occupied by the first rectangles 20 may constitute the first group and the area occupied by the second rectangles 21 the second group. The first rectangles 20 and the second rectangles 21 each may be a square.

As an alternative, the division pattern R prepared in the division pattern preparation step S20 is a striped pattern in which the first oblongs 22 having the side length equal to the minimum pitch of the two or more patterns 10 laid out in the object mask pattern U and the second oblongs 23 in the same shape as the first oblongs 22 are arranged in a staggered fashion, and in which the area occupied by the first oblongs 22 may constitute the first group and the area occupied by the second oblongs 23 the second group.

According to the pattern division method according to this embodiment, even the object mask pattern U with the patterns irregularly laid out therein can be divided into the first mask pattern UA and the second mask pattern UB without any conflict.

Also, even in the case where the first mask pattern UA and/or the second mask pattern UB after division develops an area locally crowded with the patterns (10A and 11A), the crowded patterns can be formed accurately on the substrate by conducting the OPC on the first mask pattern UA and/or the second mask pattern UB.

Incidentally, the pattern division processing apparatus and the pattern division method according to this embodiment can be used for the mask pattern having laid out therein any of the patterns including the hole pattern, the wiring pattern and the pattern to form an area for isolating an element on the substrate. Even the mask pattern with one-dimensional line patterns 10 laid out therein as shown in FIG. 12, for example, can be divided without any problem by use of the striped division pattern as illustrate. This assumption equally applies to the embodiments described below.

### Process Flow of First Embodiment

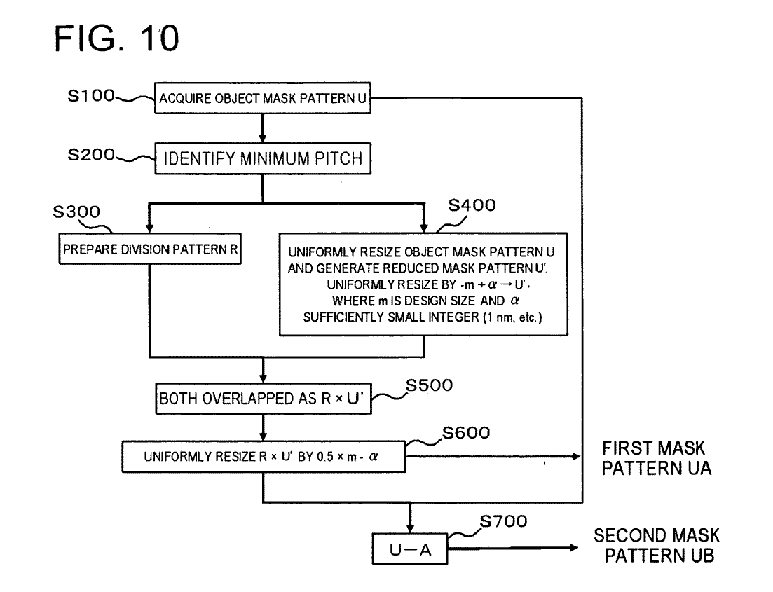

An example of the process flow embodying the pattern division method according to this embodiment using the pattern division processing apparatus according to this embodiment is described below with reference to the flowchart of FIG. 10.

In step S100, the object mask pattern U is acquired. For example, the object mask pattern U stored in the internal memory of the pattern division processing apparatus is retrieved (object mask pattern acquisition step S10).

In step S200, the minimum pitch of the two or more patterns laid out in the object mask pattern U is identified. In step S300, the division pattern R is prepared. For example, the division pattern R is generated as a checkered pattern in which the first rectangles (square) and the second rectangles (square) having the side length equal to the minimum pitch identified in step S200 are arranged in a staggered fashion (division pattern preparation step S20).

In step S400, the object mask pattern U is uniformly resized (each pattern is reduced substantially toward the center thereof) thereby to generate a reduced mask pattern U′. For example, each reduced pattern is generated which has the same center position as each of the patterns laid out before resizing in the object mask pattern U and which has the side length equal to the sum of the side length m before resizing and “−m +α” (α: sufficiently small positive value). By executing this process for all the patterns, the reduced mask pattern U′ is generated (reduced mask pattern generation step S30).

In step S500, the division pattern R and the reduced mask pattern U′ are overlapped with each other and the reduced patterns overlapped with the area (occupied by the first rectangles) classified as the first group of the division pattern R are extracted thereby to generate the first reduced mask pattern R×U′ (first reduced mask pattern generation step S40).

In step S600, the first reduced mask pattern R×U′ is uniformly resized (each pattern is restored to the state before resizing in step S400) thereby to generate the first mask pattern UA (first mask pattern generation step S50).

In step S700, the first mask pattern UA is subtracted from the object mask pattern U thereby to generate the second mask pattern UB (second mask pattern generation step S60).

After that, the OPC is conducted on the first mask pattern UA and the second mask pattern UB as required. For example, the model based OPC is conducted on the first mask pattern UA and the second mask pattern UB (OPC step S70).

### Second Embodiment

The pattern division processing apparatus and the pattern division method according to the second embodiment are different from the pattern division processing apparatus and the pattern division method according to the first embodiment in the method for generating the second mask pattern.

### Configuration of Second Embodiment

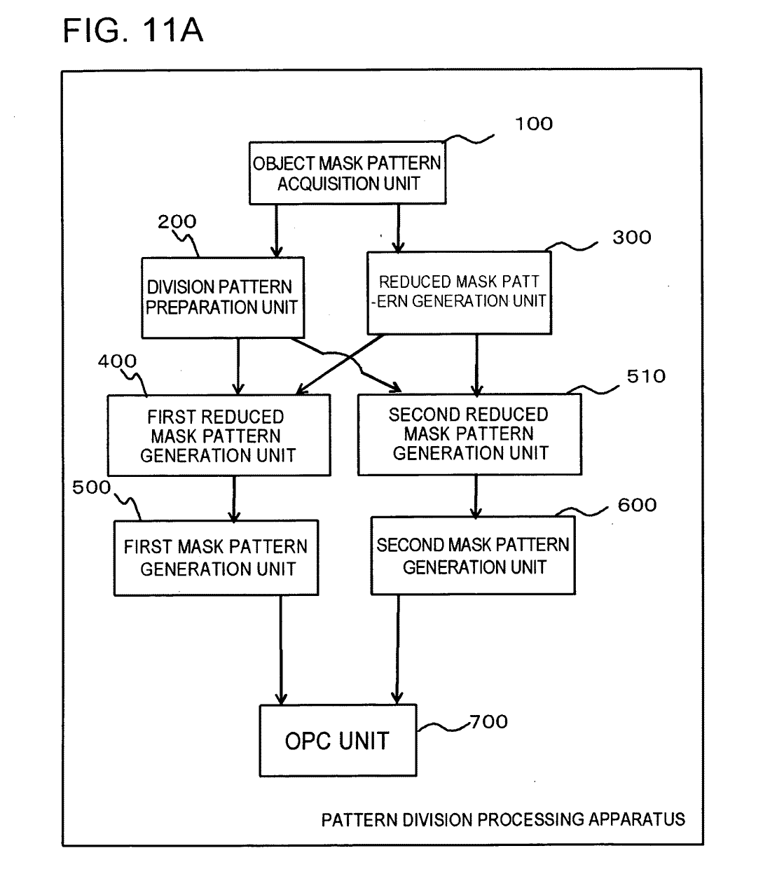

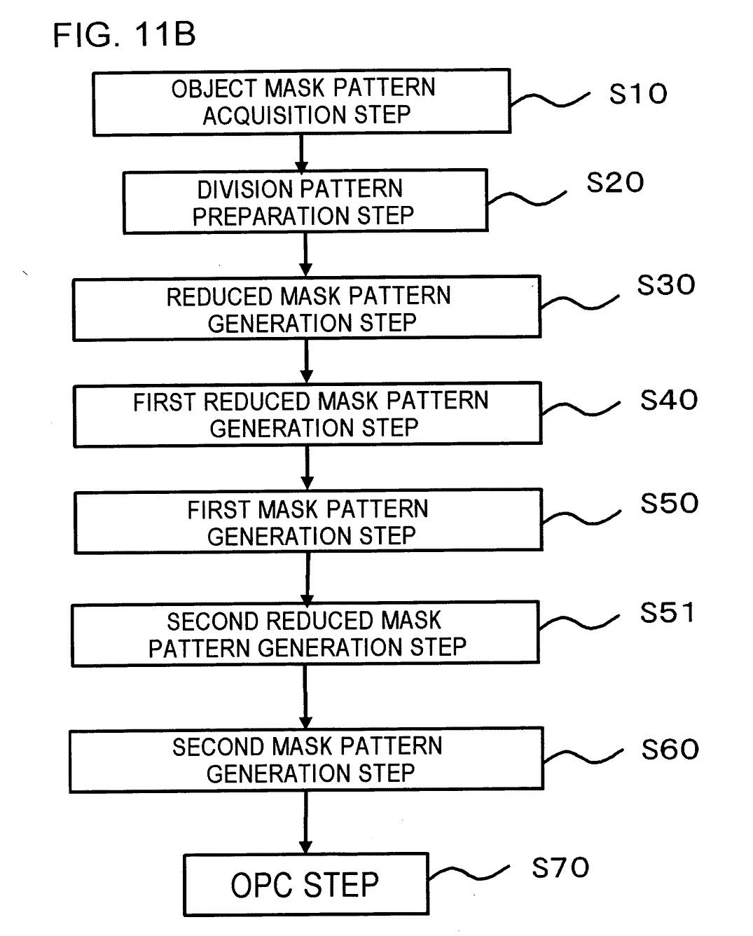

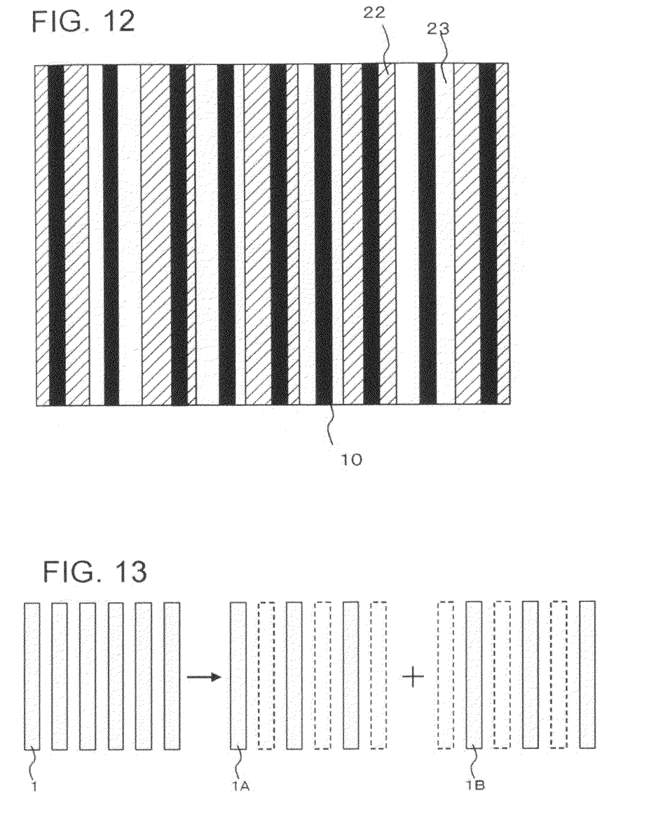

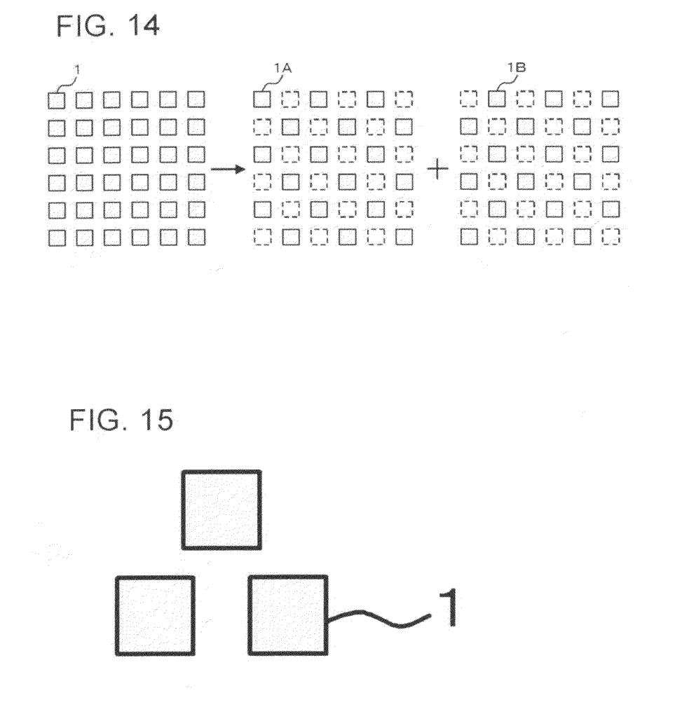

The pattern division processing apparatus according to this embodiment includes, as shown in the function block diagram of FIG. 11A, an object mask pattern acquisition unit 100, a division pattern preparation unit 200, a reduced mask pattern generation unit 300, a first reduced mask pattern generation unit 400, a first mask pattern generation unit 500, a second reduced mask pattern generation unit 510, a second mask pattern generation unit 600 and an OPC unit 700. Depending on the layout of the mask pattern, the OPC unit 700 may be done without.

The configuration of the pattern division processing apparatus according to this embodiment is described in detail below. Incidentally, the object mask pattern acquisition unit 100, the division pattern preparation unit 200, the reduced mask pattern generation unit 300, the first reduced mask pattern generation unit 400, the first mask pattern generation unit 500 and the OPC unit 700 are similar in configuration to the corresponding units, respectively, described in the first embodiment, and therefore, the detailed description thereof is not repeated.

The second reduced mask pattern generation unit 510 is configured to generate a second reduced mask pattern (not shown) by overlapping the division pattern R of FIG. 1(2) with the first reduced mask pattern U′ of FIG. 1(3) and extracting the reduced patterns (not shown) overlapped with an area (the area occupied by the second rectangles 21) classified as the second group of the division pattern R. Specifically, the second reduced mask pattern (not shown) is formed by extracting only the reduced patterns designated by a dashed line in FIG. 1(4). The second reduced mask pattern generation unit 510, like the first reduced mask pattern generation unit 400, can be realized by, for example, a tool dedicated to what may be called “the layer combination and the bias process” in wide use. The specific process executed using this tool is similar to the process using the tool dedicated to the “layer combination and the bias process” in the first reduced mask pattern generation unit 400 described in the first embodiment.

The second mask pattern generation unit 600 is configured to generate the second mask pattern UB by restoring the two or more reduced patterns (not shown) laid out in the second reduced mask pattern, to the original size before reduction by the reduced mask pattern generation unit 300. Incidentally, the second mask pattern generation unit 600 is implemented by a configuration similar to that of the first mask pattern generation unit 500 described in the first embodiment, and therefore, the detailed description thereof is not repeated.

The pattern division method according to this embodiment can be realized by causing a computer to execute a program including the process of acquiring an object mask pattern U as a mask pattern to be divided, the process of preparing a division pattern R by dividing a predetermined area into a plurality of areas and classifying the plurality of the areas into first and second groups in a staggered fashion, the process of reducing each of the two or more patterns 10 laid out in the object mask pattern U, substantially toward the center thereof thereby to generate a reduced mask pattern U′ having laid out therein the reduced patterns 11 as patterns after reduction, the process of overlapping the division pattern R with the reduced mask pattern U′ and generating a first reduced mask pattern R×U′ by extracting the reduced patterns 11 overlapped with the area classified as the first group of the division pattern R, the process of generating a first mask pattern UA by restoring the reduced mask patterns laid out in the first reduced mask pattern R×U′ to the size before execution of the reduced mask pattern generation process, the process of generating a second reduced mask pattern UB by overlapping the division pattern R with the reduced mask pattern R×U′ and extracting the reduced patterns 11 overlapped with the area classified as the second group of the division pattern R, the process of generating a second mask pattern UB by restoring the reduced patterns 11B laid out in the second reduced mask pattern to the original size before execution of the reduced mask pattern generation process, and the process of conducting the OPC on the first mask pattern UA and the second mask pattern UB. Incidentally, the program may not include the OPC process.

Also, the program described above may be constituted of either a single program to execute all the aforementioned processes continuously or a combination of a plurality of programs for a plurality of units into which the processes are divided. This program may be stored in an information storage medium such as a CD.

Next, the pattern division method according to this embodiment is described with reference to the flowchart of FIG. 11B.

The “pattern division method according to this embodiment, as shown in the flowchart of FIG. 11B, includes a second reduced mask pattern generation step S51 between the first mask pattern generation step S50 and the second mask pattern generation step S60. In this respect, this method is different from the pattern division method according to the first embodiment. Also, the process executed in the second mask pattern generation step S60 is different from the corresponding process in the pattern division method according to the first embodiment. The other parts of the configuration are similar to those of the pattern division method according to the first embodiment.

The second reduced mask pattern generation step S51 and the second mask pattern generation step S60 of the pattern division method according to this embodiment are described below.

The second reduced mask pattern generation step S51 is a step in which the division pattern R shown in FIG. 1(2) is overlapped with the first reduced mask pattern U′ shown in FIG. 1(3) and a reduced mask pattern (not shown) overlapped with the area (the area occupied by the second rectangles 21) classified as the second group of the division pattern R is extracted thereby to generate a second reduced mask pattern (not shown). This step is implemented by the process executed by the second reduced mask pattern generation unit 510 of the pattern division processing apparatus according to this embodiment.

The second mask pattern generation step S60 is a step in which the reduced patterns (not shown) laid out in the second reduced mask pattern are restored to the original size before execution of the reduced mask pattern generation step S30 thereby to generate the second mask pattern UB.

With the pattern division method, the pattern division processing apparatus and the computer program executed by the pattern division processing apparatus according to this embodiment, even an object mask pattern U having the patterns laid out irregularly therein can be divided into the first mask pattern UA and the second mask pattern UB without any conflict.

Also, even in the case where the first mask pattern UA and/or the second mask pattern UB after division develops an area locally crowded with patterns (10A and 11A), the crowded patterns can be accurately formed on the substrate by conducting the OPC on the first mask pattern UA and/or the second mask pattern UB, as the case may be.

It is apparent that the present invention is not limited to the above embodiments, and may be modified and changed without departing from the scope and spirit of the invention.

What is claimed is:

1. A pattern division method to divide at least two patterns laid out in a single mask pattern into a first mask pattern and a second mask pattern, comprising:
acquiring an object mask pattern providing a mask pattern to be divided;
preparing a division pattern by dividing a predetermined area into a plurality of areas and classifying the plurality of said areas into first and second groups in a staggered fashion;
reducing each of said at least two patterns laid out in said object mask pattern substantially toward the center of the particular pattern and generating a reduced mask pattern having reduced patterns laid out as patterns after said reduction;
overlapping said division patterns with said reduced mask pattern and extracting said reduced patterns overlapped with the area of the division pattern classified as said first group thereby to generate a first reduced mask pattern; and
restoring said reduced patterns laid out in said first reduced mask pattern to the original size before generation of said reduced mask pattern thereby to generate said first mask pattern.

2. The method according to claim 1, further comprising:
generating said second mask pattern by subtracting the patterns laid out in said first mask pattern from said at least two patterns laid out in said object mask pattern.

3. The method according to claim 1, further comprising:
generating a second reduced mask pattern by overlapping said division pattern with said reduced pattern and extracting said reduced patterns overlapped with the area classified as said second group of said division pattern; and
generating a second mask pattern by restoring said reduced patterns laid out in said second reduced mask pattern to the original size before generation of said reduced mask pattern.

4. The method according to claim 1, further comprising:
conducting the OPC on said first mask pattern and said second mask pattern.

5. The method according to claim 1,
wherein said division pattern is a checkered pattern in which first rectangles each having a side length equal to the minimum pitch of said at least two patterns and second rectangles in the same shape as said first rectangles laid out in said object mask pattern are arranged in a staggered fashion, and
the area occupied by said first rectangles is classified as said first group and the area occupied by said second rectangles as said second group.

6. The method according to claim 5,
wherein each of said first rectangles and said second rectangles is a square.

7. The method according to claim 1,
wherein said division pattern is a striped pattern in which first oblongs and second oblongs in the same shape as said first oblongs each having a side length equal to the minimum pitch of said at least two patterns laid out in said object mask pattern are arranged in a staggered fashion, and
the area occupied by said first oblongs is classified as said first group and the area occupied by said second oblongs as said second group.

8. A pattern division processing apparatus which divides at least two patterns laid out in a single mask pattern into a first mask pattern and a second mask pattern, comprising:
an object mask pattern acquisition unit which acquires an object mask pattern providing a mask pattern to be divided;
a division pattern preparation unit which prepares a division pattern by dividing a predetermined area into a plurality of areas and classifying the plurality of said areas into first and second groups in a staggered fashion;
a reduced mask pattern generation unit which reduces each of said at least two patterns laid out in said object mask pattern substantially toward the center of the particular pattern and generates a reduced mask pattern with said reduced patterns laid out as patterns after reduction;
a first reduced mask pattern generation unit which overlaps said division pattern with said reduced mask pattern and extracts said reduced patterns overlapped with the area of said division pattern classified as said first group thereby to generate a first reduced mask pattern; and
a first mask pattern generation unit which restores said reduced patterns laid out in said first reduced mask pattern to the original size before said reduction by said reduced mask pattern generation unit thereby to generate a first mask pattern.

9. The apparatus according to claim 8, further comprising:
a second mask pattern generation unit which generates said second mask pattern by subtracting the patterns laid out in said first mask pattern from said at least two patterns laid out in said object mask pattern.

10. The apparatus according to claim 8, further comprising:
a second reduced mask pattern generation unit which generates a second reduced mask pattern by overlapping said division pattern with said reduced mask pattern and extracting said reduced patterns overlapped with the area classified as said second group of said division pattern; and
a second mask pattern generation unit which generates said second mask pattern by restoring said reduced patterns laid out in said second reduced mask pattern to the original size before said reduction by said reduced mask pattern generation unit.

11. The apparatus according to claim 8, further comprising:
an OPC unit which conducts the OPC on said first mask pattern and said second mask pattern.

12. The apparatus according to claim 8,
wherein said division pattern is a checkered pattern in which first rectangles having a side length equal to the minimum pitch of said at least two patterns laid out in said object mask pattern and second rectangles in the same shape as said first rectangles are arranged in a staggered fashion, and
the area occupied by said first rectangles is classified as said first group and the area occupied by said second rectangles as said second group.

13. The apparatus according to claim 12,
wherein each of said first rectangles and said second rectangles are a square.

14. The apparatus according to claim 8,
wherein said division pattern is a striped pattern in which first oblongs each having a side length equal to the minimum pitch of said at least two patterns and second oblongs in the same shape as said first oblongs laid out in said object mask pattern are arranged in a staggered fashion, and
the area occupied by said first oblongs is classified as said first group and the area occupied by said second oblongs as said second group.

15. An information storage medium on which is stored a program executed by a computer, said program comprising:
acquiring an object mask pattern providing a mask pattern to be divided;
preparing a division pattern by dividing a predetermined area into a plurality of areas and classifying the plurality of said areas into first and second groups in a staggered fashion;
reducing each of at least two patterns laid out in said object mask pattern substantially toward the center of said particular pattern and generating a reduced mask pattern with said reduced patterns laid out therein as patterns after said reduction;
overlapping said division patterns with said reduced mask pattern and extracting said reduced patterns overlapped with the area of said division pattern classified as said first group thereby to generate a first reduced mask pattern;
restoring said reduced patterns laid out in said first reduced mask pattern to the original size before said reduced mask pattern generation thereby to generate a first mask pattern; and
subtracting the patterns laid out in said first mask pattern from said at least two patterns laid out in said object mask pattern thereby to generate a second mask pattern.

16. An information storage medium on which is stored a program executed by a computer, said program comprising:
acquiring an object mask pattern providing a mask pattern to be divided;
preparing a division pattern by dividing a predetermined area into a plurality of areas and classifying said plurality of areas into first and second groups in a staggered fashion;
reducing each of at least two patterns laid out in said object mask pattern substantially toward the center of the particular pattern and generating a reduced mask pattern with the reduced patterns laid out therein as patterns after reduction;
overlapping said division pattern with said reduced mask pattern and extracting said reduced patterns overlapped with the area of said division pattern classified as said first group thereby to generate a first reduced mask pattern;
restoring said reduced patterns laid out in said first reduced mask pattern to the original size before generation of said reduced mask pattern thereby to generate a first mask pattern;
overlapping said division pattern with said reduced mask pattern and extracting said reduced patterns overlapped with the area of said division pattern classified as said second group thereby to generate a second reduced mask pattern; and
restoring said reduced patterns laid out in said second reduced mask pattern to the original size before generation of said reduced mask pattern thereby to generate a second mask pattern.

17. The information storage medium on which is stored the program according to claim 15, said program further comprising:
conducting the OPC on said first mask pattern and said second mask pattern after generation of said second mask pattern.

18. The information storage medium on which is stored the program according to claim 16, said program further comprising:
conducting the OPC on said first mask pattern and said second mask pattern after generation of said second mask pattern.
